(19) United States
(12) Patent Application Publication
(10) Pub. No.: US 2002/0072033 A1
(43) Pub. Date: Jun. 13, 2002

(54) Dental instrument with a drive tool and a transmission device with magnetic clutch elements

(76) Inventors: Thomas Bierbaum, Bensheim (DE); Ulf Stein, Grasellenbach (DE)

Correspondence Address: Dykema Gossett PLLC, Suite 300 West, 1300 I Street, N.W., Washington, DC, 20005-3306, US

(21) Appl. No.: 10/003,293

(22) Filed: Dec. 6, 2001

(30) Foreign Application Priority Data
Dec. 12, 2000 (DE) 100 61 900.2

(51) Int. Cl. A61C 1/02

(52) U.S. Cl. 433/105

(57) ABSTRACT

A dental instrument with a drive tool and a transmission device. The instrument has a neck drive with a drive shaft housed within a first and second shank. The drive shaft has a toothed wheel at one end and the transmission device at the other end. The transmission device has at least one magnetic and/or magnetizable clutch element and means for influencing the transmission torque of the magnetic and/or magnetizable clutch elements.

### FIELD OF THE INVENTION

The invention relates to a dental instrument having a hand piece with a drive tool and a transmission device with at least one magnetic or magnetizable clutch elements.

### DESCRIPTION OF THE RELATED ART

German Patent No. DE 32 37 197 A1 discloses a hand piece with an integrated motor that serves to drive rotating tools with small dimensions. The transmission provides for rotational movement of a motor, and comprises a magnetic clutch to replace mechanic gears for the acceleration of electric motors working usually with about 667 rotations/sec (40.000 rotations per minute). Using electric motors has the advantage over turbines that the motors can transmit a higher torque to the tool.

U.S. Pat. No. 5,616,029 discloses an instrument with a hand piece that comprises a friction clutch which is effective in the direction of rotation, it is provided in addition to the rotation speed of a reduction gear unit.

The electronic torque limitation of electric motors depends on electric motor data that have production dispersions and are therefore inexact. Gear steps for the reduction of rotation speed that are downstream show different degrees of efficiency according to the state of maintenance and production tolerances. Existing torque tolerances of the motor, and the differences of the degrees of efficiency of the gear are amplified by the gear reduction ratio of the downstream gear and therefore have high tolerances.

### BRIEF SUMMARY OF THE INVENTION

The present invention has a hand piece with a drive tool. It also has a transmission device with at least one magnetic and/or magnetizable clutch element with means for influencing the transmission torque of the magnetic and/or magnetizable clutch element.

An adaption is possible for special applications with particular requirements to the type of movement and the torque, such as root canal treatment (endodonty).

Long, thin tools are used for extracting inflamed nerves. A manual treatment is commonly used to avoid breaking the extremely thin tools. Furthermore, the manual preparation is very time-consuming. Due to very different natural forms in the root canal, different tools must be used for each canal. The difference between the tools is in the length, conicity, diameter, flexibility and resistance. As such, extremely high strains of the tool are used, especially with regard to torsion and bending in curved root canals. Due to the special blade geometry of such rotating tools, the present device only needs low rotation speeds from 5 to 25 rotations per sec (300 to 2100 rotations per minute). Also, the high rotation speed of the drive motors is reduced in a reduction gear, and the torque on the tool is amplified in an unwanted manner. As the torque of the used motors is often too high, it can be a danger. The thin and highly stressed tools will break because a user cannot transmit dexterity to the mechanical system. The broken tools cannot be left in the tooth, they must be removed through a time-consuming process that often causes the loss of the tooth.

In the present invention, the motor driven hand pieces are time saving devices. The bidirectional movements, up and down movements or combinations thereof are accomplished by the use of special gears.

When a certain torque is exceeded, the magnetic clutch elements declutch, and the tool rupture can be avoided. The torque can be regulated by means of corresponding devices and so can be adapted to the different tool types. The use of magnetic clutch elements has the advantage of less wear and tear because no contact exists. A compensation of tolerances is easy, and alignment errors such as axis offset, angle errors, distance errors or cylindricity errors, and especially eccentricity, have essentially no harmful influence on the process. Furthermore, the clutch elements are electrically isolated from each other and acoustically separated so that no transmission of structure-borne sound is possible.

The transmission of the torque can be easily influenced in different manners. The air gap between the clutch elements, at least one of which is magnetic and/or can be magnetized, can be modified. This can be made by modifying, radially or axially, the distance of the magnets between each other. The air gap can also be changed by modifying the angles between input and output, and in introducing materials of other permeability.

In addition, the transmission torque can be influenced by modifying the flux guide coil on the input and/or output side. Thereby a magnetically soft element, such as a yoke, a flux guide coil or a magnet, is positioned in the zone of influence of one or more magnetic clutch elements so that the magnetic field of at least one of the magnets of the clutch elements is guided by a magnetically soft element. Thus, the magnetic force between the clutch elements is reduced.

Finally, the flux guide coil on the input and/or output side can be made by one or more electromagnets, which can be modified electronically. The modification can be made by signals from sensors or can be predetermined by external parameters such as pressure, temperature, luminosity, speed, torque, time.

The magnetic clutch means can be realized as permanent magnets or as electromagnets, and can transmit the torque, the force, or can indirectly cooperate with stationary magnets.

Due to the magnetic elements, a torque limitation independent from the rotation speed is made without contact and therefore is not subject to wear, and is independent from temperature.

It is possible to limit the torque in a focussed angle and length zone by arranging the element influencing the magnet only in a zone or a segment of the circumference. Thereby it can be fixed or can rotate together with the circumference.

Several axis can be provided in the input and/or the output of the hand piece and several clutch points can be provided.

The magnetically soft element can cooperate with switching means for influencing or starting other functions. The force acting on the element influencing the magnetic field is used, the element being attracted from the magnet(s) of the magnetic clutch element. If a coaxial arrangement of the switching elements is provided, it can be a centralizing force.

The magnetic clutch elements are chosen so that after the magnetic clutch elements are declutched, a force directed opposite the original working direction is created. The tool can be moved in the contrary sense, thereby favoring a vibratory separation of a jammed tool.

In addition, the dental instrument can have a drive motor with a high rotation speed and a reduction gear for reducing the rotation speed in a zone between 5 and 25 rotations/sec. This allows the instrument to continue to use existing drive motors when attaching the hand piece according to the invention. Other hand pieces can be attached to the motor by means of a connection point, which corresponds to the connection point of a hand piece with high rotation speed.

The transmission device with the magnetic clutch element is so formed that the threshold value of the tool torsion and bending is exceeded. So a fracture of the tool is avoided.

Especially suited is the dental instrument for the use with a tool for root canal treatment, because small torques must be transmitted.

The magnetic clutch is so arranged, that rotations are transmitted on the input side as well as on the output side. It is also possible to arrange the magnetic clutch elements so that a part of the clutch performs a rotation and the other part of the clutch performs a translation, or both parts perform translations.

The desired torque is more reproduceable and can the more be regulated, the closer to the tool the influence is performed.

Other objects, advantages and novel features of the invention will become more apparent from the following detailed description of the invention when taken in conjunction with the accompanying drawings.

### BRIEF DESCRIPTION OF THE DRAWINGS

FIG. 1a is a cross-sectional view of a neck drive of a dental hand piece of the present invention;

FIG. 1b is a cross-sectional view of the neck drive of the dental hand piece showing a switch function;

FIG. 2 is a cross-sectional view of a second embodiment of a neck drive showing a different magnetic clutch than shown in FIGS. 1a and 1b;

FIG. 3 is a cross-sectional view of a drive part of a dental angle piece with a magnetic clutch;

FIG. 4a is a schematic diagram of the magnetic properties of the magnetic clutch of FIG. 2;

FIG. 4b is a schematic diagram of the magnetic properties of the magnetic clutch of FIG. 2;

FIG. 5a is a side view of the clutch arrangment of FIG. 1 showing the magnetic flow properties of the clutch;

FIG. 5b is a side view of the clutch arrangment of FIG. 1 showing the magnetic flow properties of the clutch;

FIG. 5c is a top plan view of the clutch arrangement of FIGS. 1 and 5b showing the magnetic flow properties of the clutch;

FIG. 6 is a chart diagram showing the torque curve dependancy on the relative rotation angle between the magnetic clutch parts;

FIG. 7a is a perspective view of the magnetic clutch elements within the radial direction magnetized magnets;

FIG. 7b is a perspective view of the magnetic clutch elements within the radial direction magnetized magnets;

FIG. 7c is a perspective view of the magnetic clutch elements within the radial direction magnetized magnets;

FIG. 8a is a perspective view of a magnetic clutch with only one magnetic clutch element;

FIG. 8b is a perspective view of a magnetic clutch with only one magnetic clutch element;

FIG. 8c is a perspective view of a magnetic clutch with magnetizable clutch elements and a stationary magent;

FIG. 8d is a top plan view of a magnetic clutch with magnetizable clutch elements and a stationary magnet;

FIG. 8e is a perspective view of a magnetic clutch with magnetizable clutch elements and a stationary magnet;

FIG. 9a is a perspective view of a magnetic clutch with a rotating clutch element and a clutch element that can be moved into the translation direction;

FIG. 9b is a magnetic clutch with a rotating clutch element and a clutch element which can be moved into the translation direction;

FIG. 10a is a perspective view of a magnetic clutch with a rotating drive and a rotatable and relocatable output;

FIG. 10b is a perspective view of a magnetic clutch with a rotating drive and a rotatable and relocatable output;

FIG. 11a is a perspective view of a magnetic clutch used to transform a rotation into a translation;

FIG. 11b is a perspetive view of a magnetic clutch used to transform a rotation into a translation;

FIG. 11c is a perspective view of a magnetic clutch used to transform a rotation into a translation;

FIG. 12 is a perspective view of a magnetic clutch with a translation corresponding to multiple dimensions of the drive;

FIG. 13 is a perspective view of a magnetic clutch with multiple magnet elements that can be moved in the translation direction;

FIG. 14a is a view of a torque threshold in a specific angle zone; and

FIG. 14b is a view of a torque threshold in a specific angle zone.

### DETAILED DESCRIPTION OF THE INVENTION

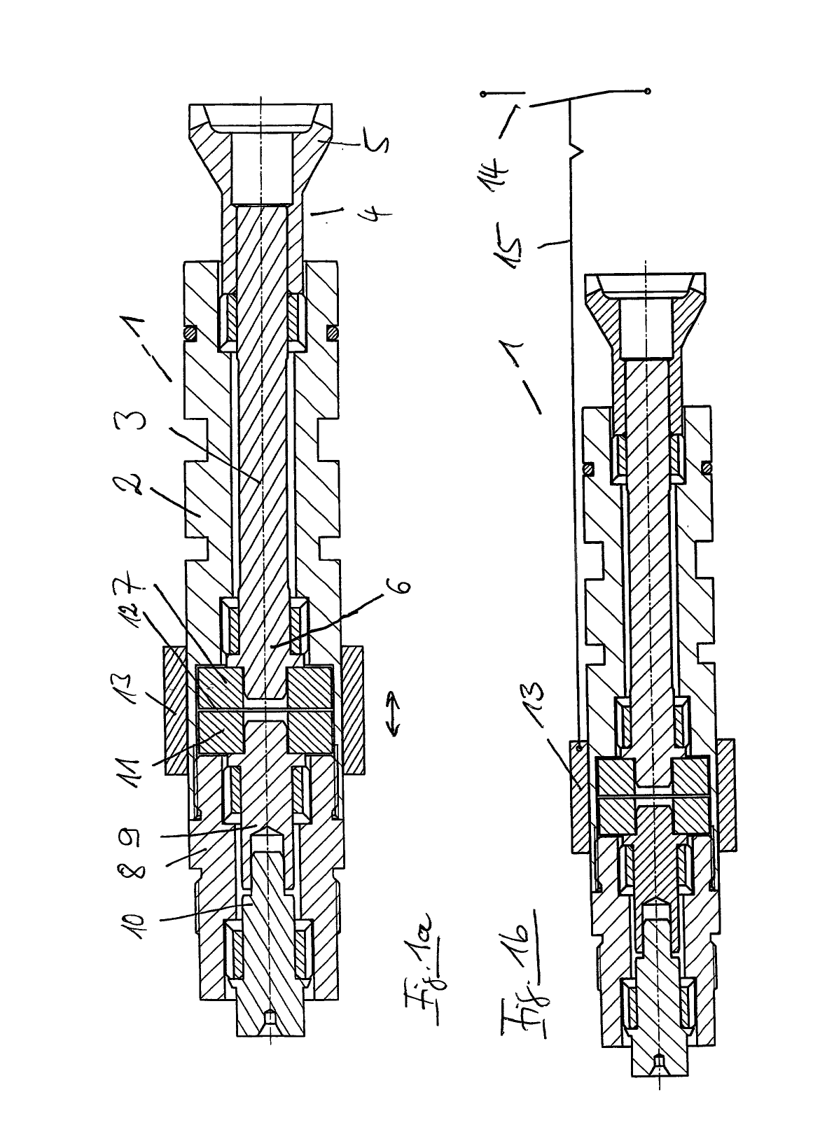

FIG. 1a shows the neck drive 1 of a dental hand piece in a longitudinal section. The neck drive 1 has a first shank 2 into which is introduced a drive shaft 3. The drive shaft 3 has on one end 4 a toothed wheel 5, and on its other end 6 a first magnetic clutch part 7.

On the shank 2 is fixed a second shank 8, in which is housed another shaft 9 with a supplementary shaft piece 10. The shaft 9 supports a second magnetic clutch part 11, which cooperates with the first clutch part 7. Between both clutch parts 7, 11 is situated an air gap 12, so that the clutch parts 7, 11 are not in contact. In addition, the clutch parts 7, 11 are rotatably housed respectively in the first shank 2 and in the second shank 8.

In order to modify the flux guide between the magnetic clutch parts 7, 11, a magnetic or magnetizable sleeve 13 is movably arranged in the zone of the clutch parts 7, 11 along the first shank 2 in a longitudinal direction. The reduction of the magnetic field is the highest in the position of the sleeve 13 in relation to the clutch parts 7, 11. When the sleeve is moved along the shanks 2, 8, the reduction of the magnetic field between the clutch parts 7, 11 and the sleeve 13 is weakened, and the transmitted torque between the clutch parts 7 and 11 is amplified.

FIG. 1b shows the neck drive 1 wherein the sleeve 13 cooperates with a switch 14. This can be made electrically or mechanically, for example by means of a proximity switch or an arrangement of rods.

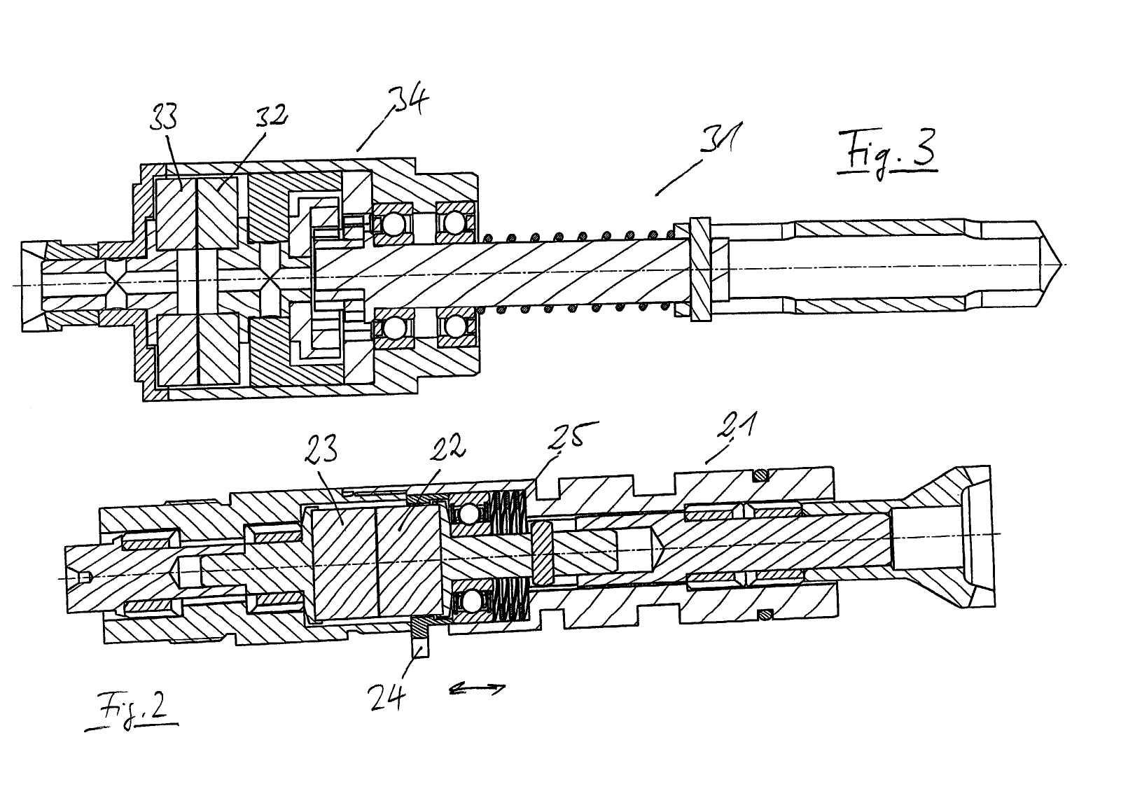

FIG. 2 discloses a second embodiment of a neck drive 21 with a magnetic clutch, wherein one of the clutch parts 22, 23 can be moved by means of a regulation device 24 against the force of a spring 25 so that the distance between the clutch parts 22, 23 and the air gap therebetween increases.

The neck drive 1 of the Figure 1a, as well as the neck drive 21 of the FIG. 2, can be positioned in an angle with respect to a drive part 31 represented in the FIG. 3. The drive part 31 has a connection on a drive motor, which is not represented, so that a dental angle piece is created. Also the drive part 31 has a magnetic clutch with clutch parts 32, 33, that can be influenced by a corresponding transmission of the sleeve 13 known from the neck drive 1 of FIG. 1. In addition, a reduction gear 34 is provided in the drive part 31 which reduces the high rotation speed produced from the drive motor. As the reduction amplifies in a corresponding manner, the torque on the output side, the torque threshold, can be made by means of the magnetic clutch with the clutch parts 32, 33.

In general, it is accepted that the torque which is transmitted by means of the clutch depends highly from the choice of the magnet material, because different materials of permanent magnets have different magnetic forces. Normally, it is not necessary to use materials with a high magnetic force, because the admitted torques of the treatment tool are relatively small.

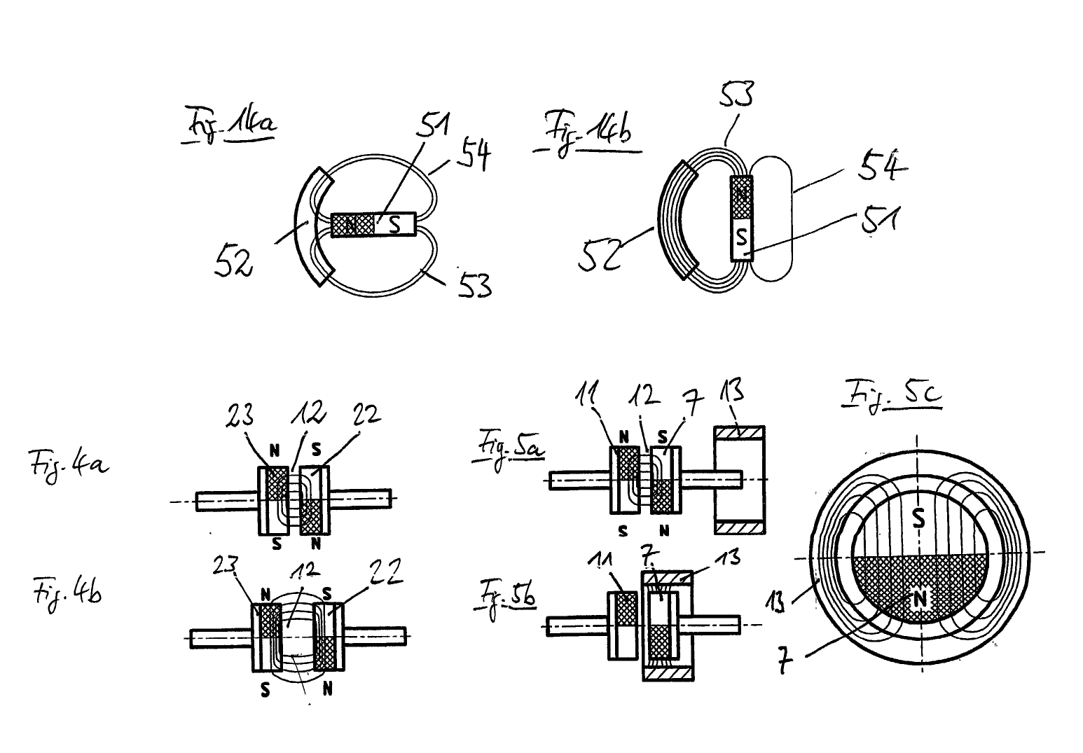

In FIGS. 4a and 4b is shown the active principle of one of the magnetic clutches wherein the letters “N” and “S” are abbreviations for the north pole and the south pole of a magnet. A modification of the air gap 12 between the magnetic clutch parts 22, 23 modifies the transmissible torque. So in the position according to FIG. 4a, it is possible to transmit a greater torque by means of the magnetic clutch than for the position shown in the FIG. 4b of the clutch parts 22, 23, even though the greater air gap 12 is larger.

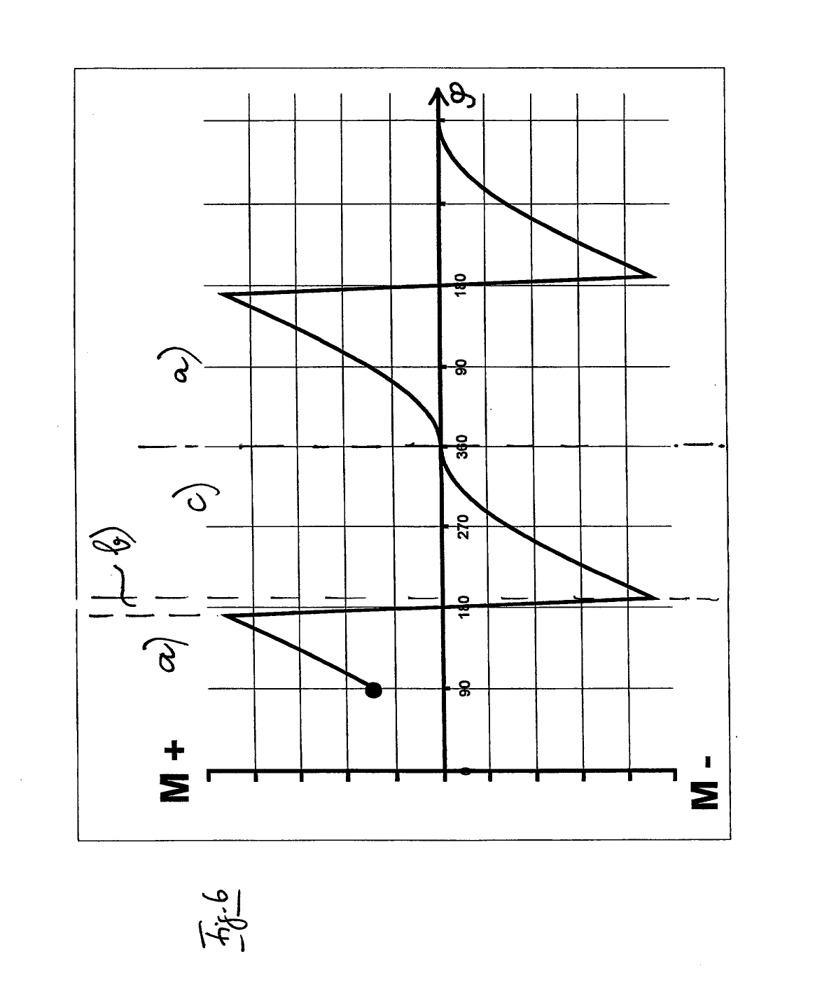

FIGS. 5a and 5b show the mode of action of the clutch arrangement as represented in FIG. 1. FIG. 5 shows the magnetic clutch with the clutch parts 7,11. The clutch parts 7,11 have a distance and an air gap 12. The magnetic flux is represented by designated lines. The sleeve 13 is so distant from the clutch parts 7, 11, that it exerts no influence on the clutch parts 7,11. The sleeve is made of a magnetically good conducting material.

FIG. 5b depicts the sleeve 13 slid over the clutch part 7 so that the magnetic flux goes partially from the clutch part 7 through the sleeve 13, wherein the torque, which is transferable on the clutch part 11, is weakened.

In order to avoid a magnetic shortcut, the clutch parts 7, 11 (FIG. 4) and 22, 23 (FIG. 5) are made of a material which is not magnetizable or is only magnetizable with great difficulty. The clutch parts 7, 11 and 22, 23 are made to support the permanent magnet.

FIG. 5c shows the clutch part 7 and the sleeve 13, as well as hypothetical flow lines which better illustrate the functioning of the sleeve 13.

FIG. 6 is a chart showing a torque curve for the dependence of the rotation angles between the magnetic clutch parts. The torque M is shown over the rotation angle φ. The diagram begins with an angle position between both clutch parts in a theoretical working point of 90° (zone a) which can arrive for a normal service with a loaded output. The input torque and the output torque are situated inferior to the regulated maximum. In the zone between 0 and <180° the output torque, which is necessary for the rotation of the treatment tool increased. The increase is represented with the curve superior to an angle of 90°. Shortly before equalling a rotation angle of 180°, the highest transmissible torque is equalled for the highest transmissible torque. The magnetic clutch part of the output is stopped. Because of the polarization of the magnetic clutch parts of the input and the output (zone b), a negative output torque occurs when the output continues to rotate, and the reversal of the rotation of the output is reached. In this position, input and output rotate in opposite directions. When the rotation angle of the input continues to increase with respect to the output, the negative output torque re-decreases, and with a rotation angle of 360° the magnets face with their opposite poles. In this position no torque can be transmitted.

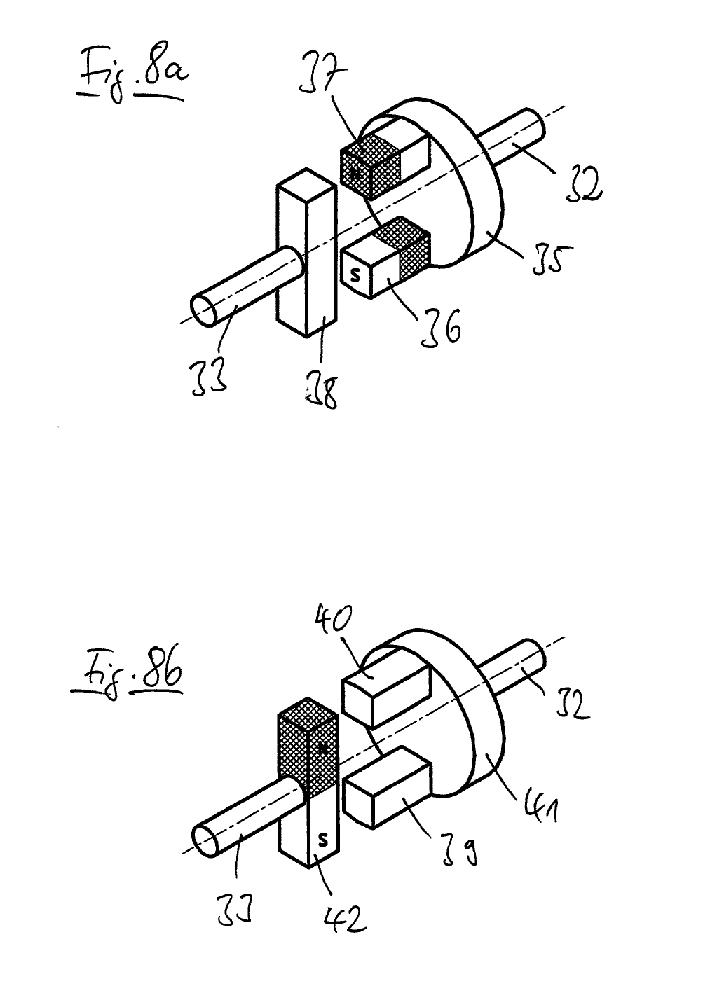

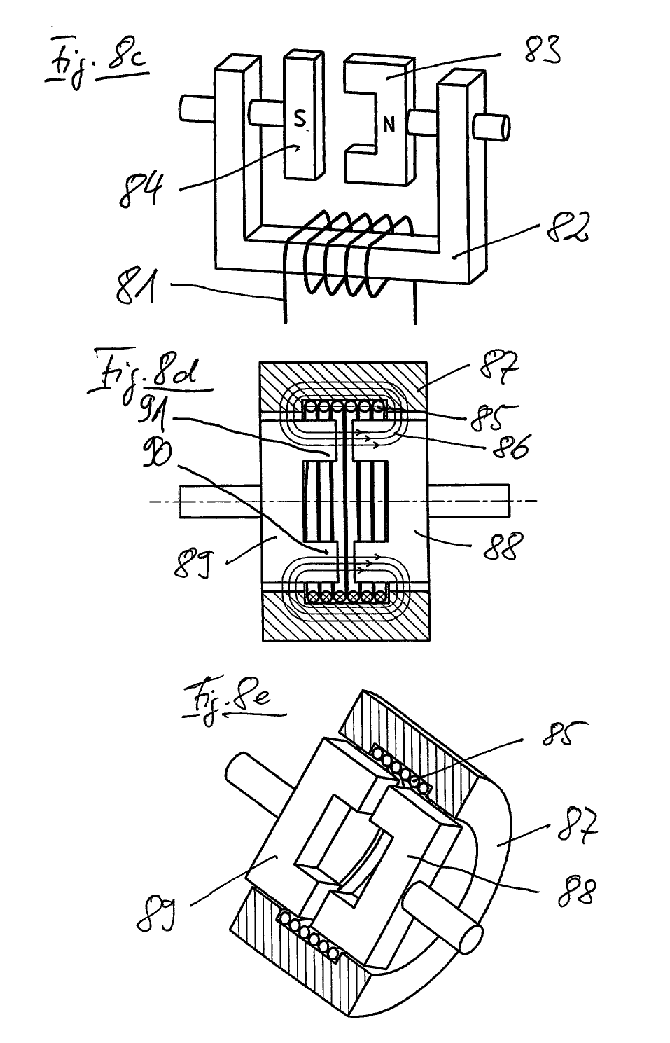

The curve of the output torque is qualitatively represented and depends strongly on the geometric dimensions of the parts. The period of the curve depends on the number of magnets and/or the design of the claw formed clutch parts, see also FIG. 8c-e.

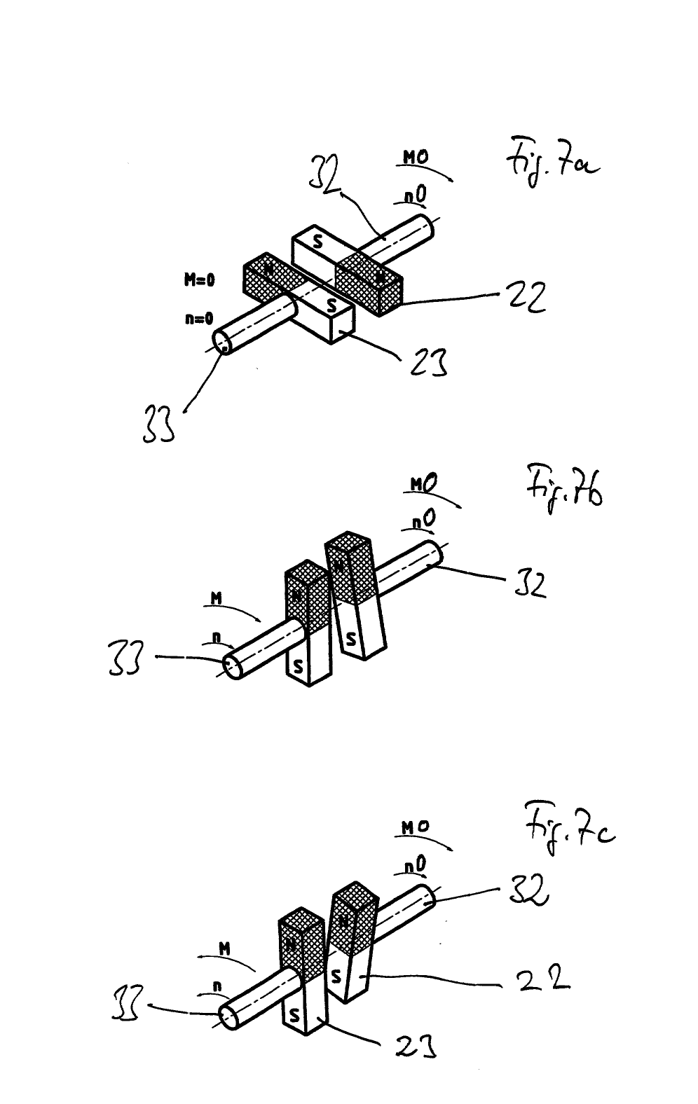

In FIGS. 7a to 7c are represented magnetic clutch elements with radial direction magnetized magnets. The magnetic coupling also works with a magnet or a yoke on the input or output side, compare FIG. 8a. In FIG. 7a, the magnetic clutch parts 22, 23 face each other with their opposite poles. In this position no torque can be transmitted to the output 33. The input 32 is loaded with the rotation speed n and a torque of M0, so that the position represented on FIG. 7a is only an instant image. The sense of rotation and the direction of the input torque M0 is indicated by the arrows.

In rotating the input 32, a greater output torque can be transmitted to the output 33, when the rotation angle increases. Also, the input torque M0 and the input rotation speed n0 are going in the same direction as the output torque M and the output rotation speed n. The output torque M moves along the curve, represented in zone a of FIG. 6, and increases up to a maximum value. This maximum value is situated in the embodiment in the zone of 180°, and more particularly at a value less than 180°. When this maximum value is equalled, the torque curve overbalances and goes into the reverse, as is represented in the zone b of FIG. 6. When the position shown in FIG. 7c is reached, the input represents the torque M0 and the rotation speed n0, which can be constant. Because the magnetic clutch part 22 has rotated over the magnetic clutch part 23 of the output 33, a negative torque M and an opposite rotation sense is created on the output 33. In this position input and output rotate in opposite senses, as it is represented on FIG. 6. This mode of action can also be used to rotate the tool arranged at the output side in the opposite direction or to loosen it, when it is jammed. By the choice of the magnets, a torque can be created in the opposite direction of the original working direction after the declutching. Thereby a gear, which is arranged behind the magnetic clutch, can support the impact.

FIGS. 8a and 8b show that it is sufficient when one of the clutch parts is magnetic. A disc provided is at the input 32 upon which are arranged two rod magnets that are directed in the opposite sense. That is, the south pole of the magnet 36 and the north pole of the magnet 37 are directed in the same sense (FIG. 8). On the output side 33 is arranged a yoke 38 which is low retentive and which is moved under the influence of the magnets 36, 37.

In FIG. 8b it works in an opposite way. The input 32 supports a yoke which comprises two arms 39, 40 and the output 33 is equipped with one rod magnet 42. If the yoke 41, with its two arms 39, 40 is turned further than the magnet 42, the torque can be transmitted. A magnetic field is created in the stator 82 (FIG. 8c) by means of an electric spool 81. The magnetic field is closed between the parts 83 and 84, which are rotatably housed in the stator 82. A torque can be transmitted between the parts 83 and 84 depending on the electrical supply of the electric spool 81 by means of an adapted geometric arrangement. In modifying the magnetic force of an electromagnet, the transmissible clutch torque can be influenced. This means a non rotating magnet is directly influenced. The rotating parts which transmit the torque, serve to conduct and guide the field.

In FIG. 8d and 8e is shown another stationary magnet that is formed as an electromagnet. The magnetic field which is created by means of a spool 85 is closed by a flux guide coil 87 and the torque clutch 88, 89. The torque is transmitted by the claw-formed clutch parts 88, 89. The electromagnet, the field strength of which can be regulated, allows a regulation of the threshold torque. The number of opposite poles 90, 91 form the flux guide coil 87 and influences the characteristics of the clutch. The external poles 90, 91 collect the flux lines at a great distance from the rotation axis, so that the transmissible torque is relatively great. Due to the number of elevations, the rotation angle between the input and output shaft is prescribed until the next snapping.

By rotating the input side, instead of the rotation of the output, a translation is created. In FIG. 9a the reciprocally polarized magnets of the input side 32 of the output are represented by an arrow 9a. In FIG. 9b is represented the opposite position of the input 32, in which exists a maximum repulsion of the output side, represented by means of the arrow 9b. The rotation of the input side 32 is transformed into a bidirectional movement of the output 33.

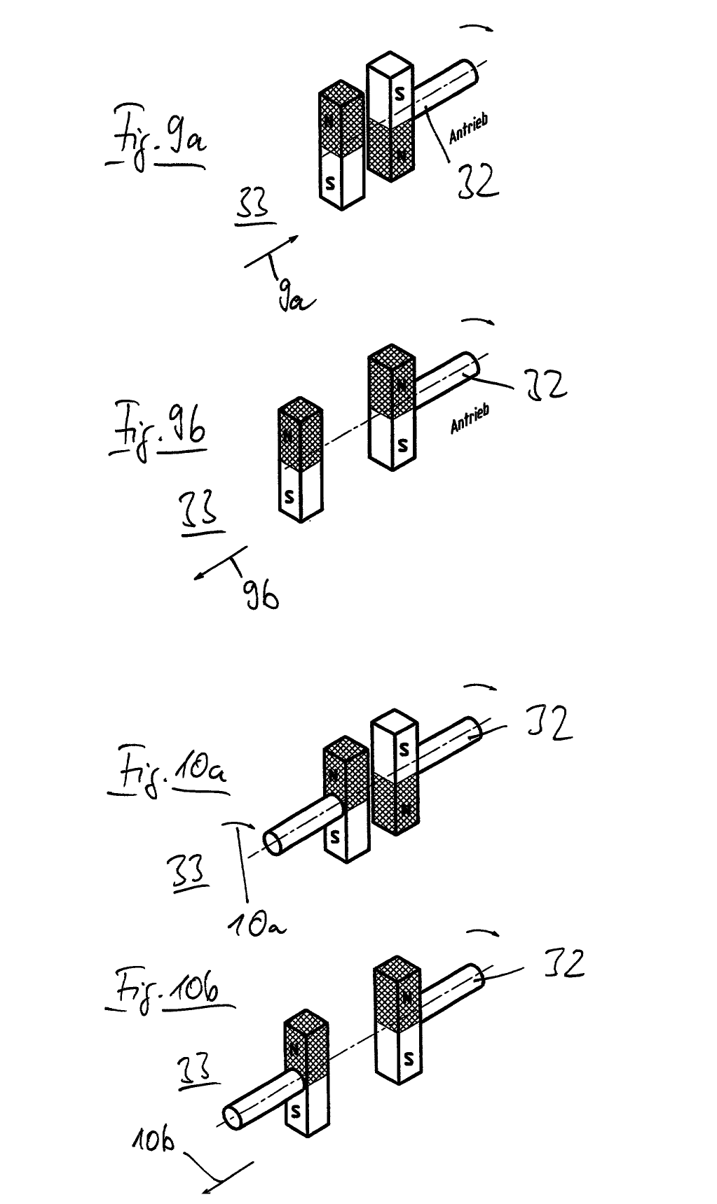

FIGS. 10a and 10b show another execution of the magnetic clutch, for which the output side executes a translation in addition to a rotation together with the input side 32 when the rotation is blocked. In FIG. 10a, a torque 10a is indicated on the output, the torque of the output goes together with the torque of the input side 32 into the same direction. When the output is blocked, a translation of the output 33 is executed according to FIG. 10b on the output side by arrow 10b. The mode of action corresponds in this case to the sequence represented in the FIGS. 9a and 9b.

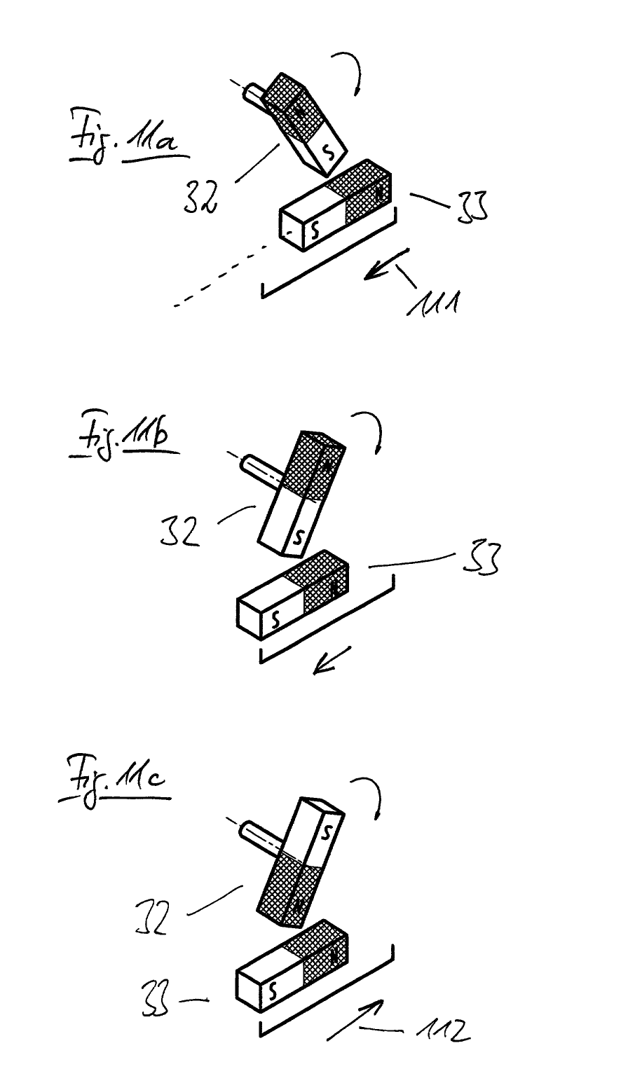

In FIGS. 11a and 11c is shown another type of transformation of a rotation into a translation. The input side 32 has a radially magnetized magnet, and the output side 33 has a rod magnet. The output 33 is linked to the tool in an adapted manner. When the south pole of the input is passing in front of the north pole of the output 33, a magnetic force is created which draws the output 33 into the direction of the arrow 11, wherein there is created the position represented in FIG. 11b. A further rotation of the input 32 is created by the attraction of the north pole of the input with the south pole of the output, wherein the output is moved in a direction of the arrow 112 in FIG. 11c. The output 33 so returns into the original position represented in FIG. 11a.

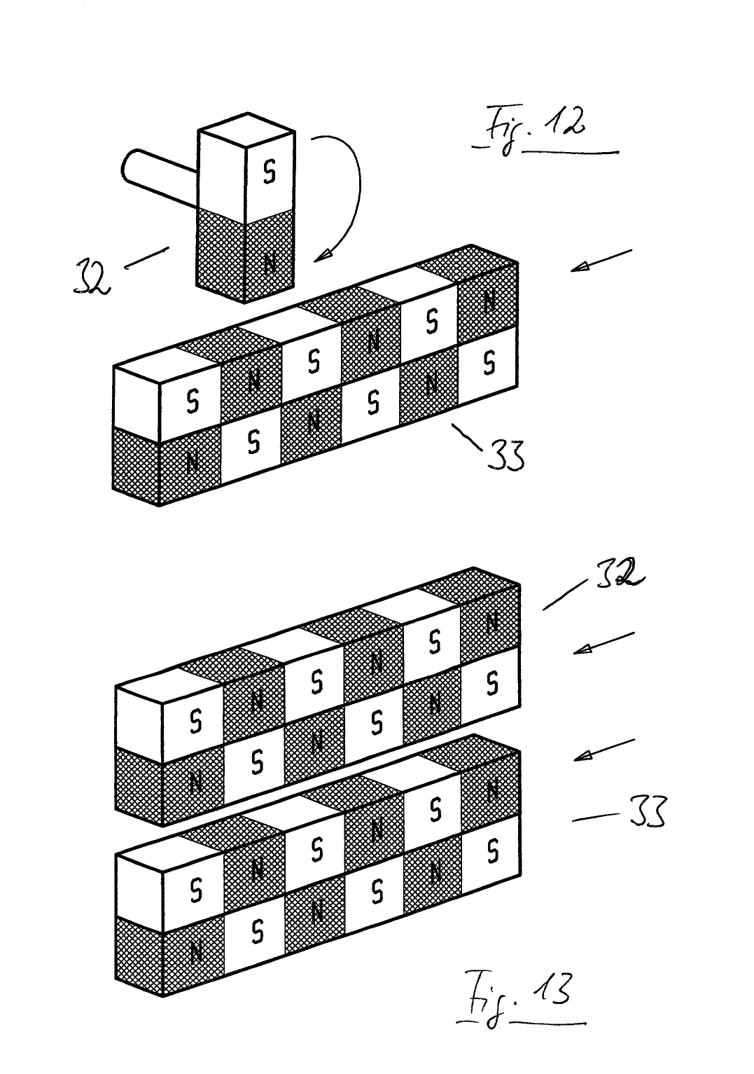

The basic principle of weakening the magnetic field for reducing the transmissible torque can also be applied to the transmission of a pure translation, as it is represented in FIG. 13.

A clutch part 32 is oscillating in the direction of the translation on the input side and there is associated a clutch part 33 on the output side, which can also be moved into the direction of the translation. If the input 32 is moving back and forth, the output 33 follows the movement until the limit of the transmissible force is reached. In this case, the output blocks and the input continues to move back and forth, whereby an overload of the tool is avoided on the output. The forces which can be transmitted between the clutch parts 32, 33, are modified by parts not shown within the scope of this invention.

FIG. 14a shows a torque threshold in a determined angle zone. A trace of the field lines 53, 54 is qualitatively represented starting from the magnetic clutch part 51 and low retentive part 52, and extending for only a certain portion of the circumference. In the represented position, a part of the field lines 53, 54 flow through the part 52, whereas the part 52 is arranged in front of the magnetic pole of the clutch part 51.

In FIG. 14b, the clutch part 51 is rotated 90° from that shown in FIG. 14a. The field lines 53 flow between the poles through the part 52. The magnetic field is more attenuated than in the position of FIG. 14a. When the magnetic clutch part 51 is rotating, consequently the reduction of the transmissible torque varies depending on the angle position with respect to the output element not shown.

What is claimed is:

1. A dental instrument having a drive tool and a transmission device with at least one magnetic and/or magnetizable clutch element, each clutch element having an air gap and a flux guide coil, the instrument comprising:
a means for influencing the transmission torque of the magnetic and/or magnetizable clutch element.

2. The dental instrument according to claim 1, further comprising:
a means for modifying the air gap of the clutch element.

3. The dental instrument according to claim 1, further comprising:
a means for modifying the flux guide coil of the magnetic clutch element.

4. The dental instrument according to claim 3, wherein:
the means for modifying the flux guide coil is positioned in the zone of influence of one or more clutch elements.

5. The dental instrument according to claim 3, wherein:
the means for modifying the flux guide coil is an electromagnet.

6. The dental instrument according to claim 5, wherein:
the magnetic force of the electromagnet is controlled according to service parameters.

7. The dental instrument according to claim 5, wherein:
the flux guide coil is indirectly modified by stationary magnets.

8. The dental instrument according to claim 5, wherein:
the flux guide coil is directly modified by moving magnets, and
the moving magnets transfer the torque with respect to the magnetic force.

9. The dental instrument according to claim 4, further comprising:
a softly magnetized part,
the low retentive part is only effective in a subzone of the magnetic clutch element.

10. The dental instrument according to claim 4, wherein:
switching means are provided that cooperate with the magnetic clutch element and the low retentive part.

11. The dental instrument according to claim 1, wherein:
the magnetic clutch elements are chosen in such a manner, that after the declutching of the magnetic clutch elements a force is created, which is opposite to the original working direction, by means of which the tool can be moved into the opposite direction.

12. The dental instrument according to claim 1, further comprising:
a neck drive;
a drive motor with high rotation speed; and
a reduction gear for reducing the rotation speeds in a zone between 5 and 25 rotations/sec. (300 to 2100 rotations/minute).

13. The dental instrument according to claim 1, wherein:
the drive tool can be loaded with torsion up to a threshold value; and
the transmitting device is formed with the magnetic clutch element so that the threshold value of the drive tool is never reached.

14. The dental instrument according to claims 1, further comprising:
a tool for root canal treatment.

15. The dental instrument according to claim 1, wherein:
the magnetic clutch element is arranged so that rotations are transmitted on an input side and on an output side.

16. The dental instrument according to claim 1, wherein:
The magnetic clutch element is arranged such that a part of the clutch performs a rotation, and the other part of the clutch performs a translation.

17. The dental instrument according to claim 1, wherein:
both magnetic clutch elements perform translations.

18. The dental instrument according claim 1, wherein:
a connection point is provided on a motor,
said connection point corresponds to the connection point of a tool working with a high rotation speed.
